(19) United States
(12) Patent Application Publication
(10) Pub. No.: US 2008/0198235 A1
(43) Pub. Date: Aug. 21, 2008

(54) HIGH DYNAMIC RANGE IMAGE RECORDER

(76) Inventors: Shou-Lung CHEN, Hong Kong (HK); Chen-Jung TSAI, Hong Kong (HK); Danding HUANG, Hong Kong (HK); Ying LIU, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/676,057

(22) Filed: Feb. 16, 2007

(51) Int. Cl. H04N 5/225

(52) U.S. Cl. 348/207.99; 348/E05.025

(57) ABSTRACT

Methods and devices (400, 500) for capturing at least one digital image (550) are described. In one implementation, transmission of input light is modulated (410) onto the same pixel elements of a digital image sensor (420), comprising pixel elements. Frames of an image are captured having different exposures (440A, 440B, 440C) from the modulated transmission of the input light using the digital image sensor (420). The different exposure frames of the image are processed to produce a high dynamic range digital image (450). In another implementation, a portion of the input light is transmitted onto the same pixel elements of respective digital image sensors (530, 532) to produce frames (560A, 560B) of an image (550) having different exposures. The different exposure frames (560A, 560B) of the image are processed (540) to produce a high dynamic range digital image (570).

### TECHNICAL FIELD

The present invention relates generally to enhanced digital image capture more particularly and to digital image processing.

### BACKGROUND

A number of approaches have been developed attempting to increase the dynamic range of captured images, especially in relation to contrast and spatial resolution.

FIG. 1A is a diagram of an array of pixels of a sensor 100, each pixel element containing four multi-cells 110 in accordance with one technique developed to address this issue. The four multi-cells, e0, e1, e2 and e3, have different corresponding sensitivities, as shown in FIG. 1B. Using multi-cells with different sensitivities, four exposure conditions' images can be obtained. Furthermore, a high dynamic range image can be merged by special image processing. However, the spatial resolution is reduced by separating one original image pixel into multi-cells. In the example shown, the resolution becomes ¼^{th} the original resolution. FIG. 1C shows a complicated and expensive arrangement of primary and secondary photodiodes. The arrangement uses different sizes of primary and secondary photodiodes to create different sensitivities. Using image processing, a high dynamic range image can be obtained. Again, the resolution significantly decreases.

FIG. 2A shows a sensor array for a high dynamic range camera, and FIG. 2B is a timing diagram illustrating the process of capturing pictures with different exposure times using the sensor array of FIG. 2A. Controlling different exposure times to create different exposure conditions images can be used to obtain a high dynamic range picture. However, when recording motion object, the time interval method disadvantageously induces the phenomenon of motion blurring. Consequently, such a device implementing this method is unsuitable as a video recorder.

Thus, a need clearly exists for an improved digital image capture device.

### SUMMARY

In accordance with an aspect of the invention, there is provided a digital image capture device, comprising: a digital image sensor comprising pixel elements; an electronic light modulator disposed between incident light and the image sensor; and an image processing unit. The electronic light modulator modulates transmission of the input light onto the same pixel elements of the digital image sensor. The digital image sensor and the light modulator are operable in a coordinated manner to produce a plurality of frames of an image having different exposures. The image processing unit processes the different exposure frames of the image to produce a high dynamic range digital image.

The digital image capture device may further comprise an optical lens system for focusing input light on the image sensor.

The digital image capture device may further comprise a controller for controlling the digital image sensor and the light modulator to be operable in a coordinated manner. The controller may be a digital processing device. Alternatively, the image processing unit may operate as a controller for controlling the digital image sensor and the light modulator to be operable in a coordinated manner. The digital image capture device may further comprise a sensor coupled to the controller to sense ambient lighting to effect coordinated operation of the digital image sensor and the electronic light modulator.

The digital image sensor may comprise a charge-coupled device (CCD) or CMOS sensor array.

The light modulator may comprise a liquid crystal display (LCD), a liquid crystal on silicon (LCOS) device, or a digital light processor (DLP).

The image processing unit may comprise a digital signal processor.

The digital image capture device may be a still image camera, a video camera for recording digital video, or both.

In accordance with another aspect of the invention, there is provided a method of capturing at least one digital image, the method comprising the steps of: modulating transmission of input light onto the same pixel elements of a digital image sensor comprising pixel elements; capturing a plurality of frames of an image having different exposures from the modulated transmission of the input light using the digital image sensor; and processing the different exposure frames of the image to produce a high dynamic range digital image.

The method may further comprise the step of focusing the input light on the digital image sensor.

The method may further comprise the step of controlling the digital image sensor and an electronic light modulator to be operable in a coordinated manner.

The method may further comprise the step of sensing ambient lighting to effect coordinated operation of the digital image sensor and the electronic light modulator.

The digital image sensor may comprise a charge-coupled device (CCD) or CMOS sensor array.

The modulating step may be implemented using a liquid crystal display (LCD), a liquid crystal on silicon (LCoS) device, or a digital light processor (DLP).

In accordance with yet another aspect of the invention, there is provided a digital image capture device, comprising: digital image sensors each comprising pixel elements; an optical light extraction unit disposed between input light and the image sensors adapted to transmit a portion of the input light onto the same pixel elements of respective digital image sensors to produce frames of an image having different exposures; and an image processing unit to process the different exposure frames of the image to produce a high dynamic range digital image.

The digital image capture device may further comprise an optical lens system for focusing the input light on the image sensors.

The digital image capture device may further comprise a controller for controlling the digital image sensors to be operable in a coordinated manner.

The controller may be a digital processing device. Alternatively, the image processing unit operates as a controller for controlling the digital image sensors to be operable in a coordinated manner.

The digital image sensors may comprise charge-coupled devices (CCD), or CMOS sensor arrays, or a combination thereof.

The light extraction unit may comprise a beam splitter. The light extraction unit may further comprise one or more optical coatings for modulating transmission of the input light to respective digital image sensors.

The image processing unit may comprise a digital signal processor.

The digital image capture device may be a still image camera, a video camera for recording digital video, or both.

The light extraction unit may provide different luminous flux to at least two of the digital image sensors.

At least two of the digital image sensors may have the same or substantially the same sensitivity.

At least two of the digital image sensors may have different sensitivities.

The image processing unit may process the different exposure frames of the image to produce a high dynamic range digital image.

In accordance with still another aspect of the invention, there is provided a method of capturing at least one digital image, the method comprising the steps of: transmitting a portion of input light onto the same pixel elements of respective digital image sensors, each comprising pixel elements, to produce frames of an image having different exposures; and processing the different exposure frames of the image to produce a high dynamic range digital image.

The method may further comprise the step of focusing input light on the digital image sensors.

The method may further comprise the step of controlling the digital image sensors to be operable in a coordinated manner.

The digital image sensors may comprise charge-coupled devices (CCD), or CMOS sensor arrays, or a combination thereof.

The transmitting step may be implemented using an optical light extraction unit.

The light extraction unit may comprise a beam splitter.

The light extraction unit may further comprise one or more optical coatings for modulating transmission of the input light to respective digital image sensors.

The method may further comprise the step of providing different luminous flux to at least two of the digital image sensors.

At least two of the digital image sensors may have the same or substantially the same sensitivity.

At least two of the digital image sensors may have different sensitivities.

The image processing unit may processes the different exposure frames of the image to produce a high dynamic range digital image.

### BRIEF DESCRIPTION OF THE DRAWINGS

Embodiments of the invention are described hereinafter with reference to the drawings, in which:

FIG. 1A is a diagram of an array of pixels, each containing multi-cells;

FIG. 1B is a plot of the sensitivities for each cell;

FIG. 1C is a diagram of a CCD array with primary and secondary photodiodes;

FIG. 2A is diagram sketch of a sensor array for a high dynamic range camera;

FIG. 2B is a timing diagram illustrating the process of capturing pictures with different exposure times using the sensor array of FIG. 2A;

FIG. 3 is a block diagram of camera system for producing high dynamic range digital images;

FIG. 4 is a block diagram of a digital image capture device for producing one or more high dynamic range digital images in accordance with an embodiment of the invention; and

FIG. 5 is a block diagram of a digital image capture device for producing one or more high dynamic range digital images in accordance with a further embodiment of the invention.

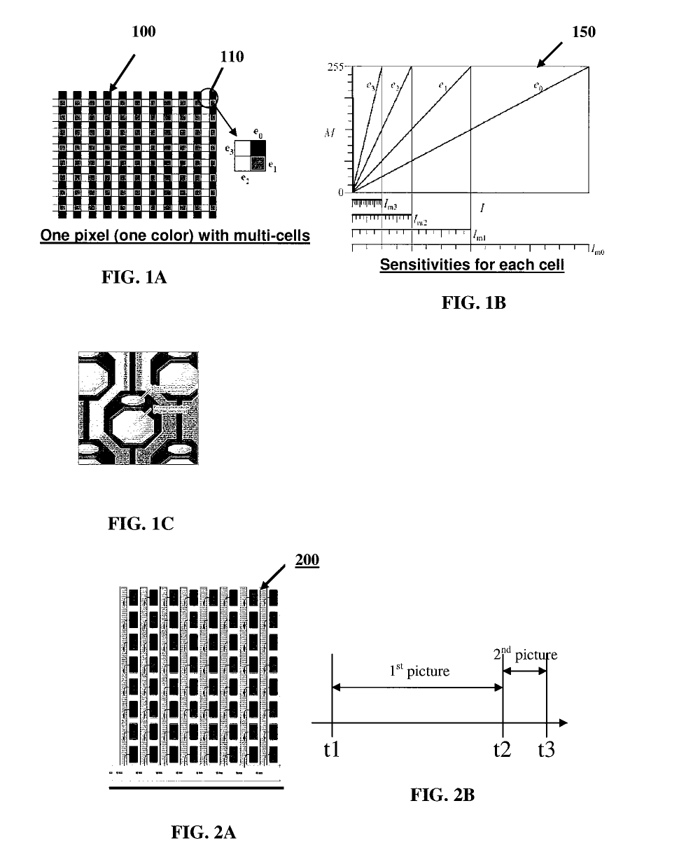

### DETAILED DESCRIPTION

Methods and devices for capturing at least one digital image are disclosed hereinafter. In the following description, numerous specific details, including optical lens systems, image resolutions, digital image sensors, and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings to steps and/or features, which have the same or like reference numerals, those steps and/or features have for the purposes of this description the same function(s) or operation(s), unless the contrary intention appears.

In the context of this specification, the word “comprising” has an open-ended, non-exclusive meaning: “including principally, but not necessarily solely”, but neither “consisting essentially of” nor “consisting only of”. Variances of the word “comprising”, such as “comprise” and “comprises”, have corresponding meanings.

FIG. 3 is a block diagram of a digital image camera 300 with which embodiments of the invention may be practiced. Commonly, such cameras 300 are capable of recording both still images and digital videos. For ease of description, the embodiments of the invention are described with reference to “at least one digital image”, which covers a single still image or a sequence of images comprising a video stream. As illustrated, four different images or frames 320A-320D are captured with different exposure levels (ex-1, ex-2, ex-3, ex-4, which are progressively less exposure) of an image, and these different exposure images or frames 320A-320D are provided to a digital image processor 310. The digital image processor 310 processes the four different exposure frames 320A-320D to produce a high dynamic range digital image 330.

Broadly speaking, in an embodiment of the invention, a method of capturing at least one digital image is disclosed. Input light is focused on a digital image sensor comprising an array of pixel elements. The digital image sensor may comprise a charge-coupled device (CCD) or CMOS sensor array. Transmission of the input light is modulated onto the same pixel elements of the digital image sensor. The modulating step is electronically implemented using a liquid crystal display (LCD), a liquid crystal on silicon (LCOS) device, or a digital light processor (DLP). Frames of an image having different exposures from the modulated transmission of the input light are captured using the digital image sensor. The different exposure frames of the image are processed to produce a high dynamic range digital image. The digital image sensor and the electronic light modulator are controlled to be operable in a coordinated manner.

In another embodiment, the input light is focused on at least two digital image sensors, each comprising an array of pixel elements. The digital image sensors are controlled to be operable in a coordinated manner. The digital image sensors may comprise charge-coupled devices (CCD), or CMOS sensor arrays, or a combination thereof. A portion of the input light is transmitted onto the same pixel elements of respective digital image sensors to produce frames of an image having different exposures. The transmitting step is implemented using an optical light extraction unit. The light extraction unit may comprise a beam splitter, and may further comprise one or more optical coatings for modulating transmission of the input light to respective digital image sensors. The different exposure frames of the image are processed to produce a high dynamic range digital image.

The embodiments of the invention are able to produce a high dynamic range image or videos. The embodiments are able to provide higher contrast (light to dark). The embodiments are also able to produce higher number of bits per color, where the current standard level is 8 bits, but may be 16 or 32 bits in the future. Further details of the embodiments of the invention are set forth hereinafter. Compared to the use of a pure digital processing method (e.g., a image-by-image capturing sensor and then producing a high-dynamic-range-like picture using a differencing or other optimized algorithm), the embodiments of the invention can create realer, vivid and more detailed pictures.

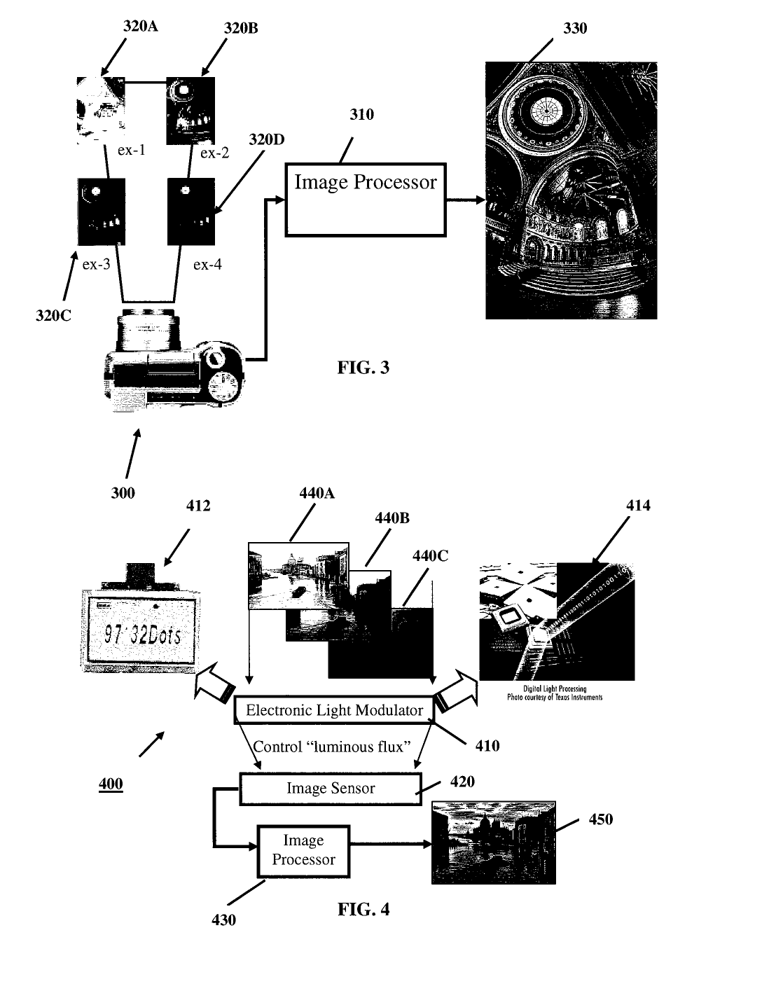

FIG. 4 is a block diagram of a digital image capture device 400 in accordance with an embodiment of the invention. The device 400 comprises an electronic light modulator 410, a digital image sensor 420, and a digital image processor 430. The device 400 may be a digital still cameral, a digital video camera or both, like the camera 300 of FIG. 3. Such a camera 300 comprises an optical lens system (not shown in FIG. 4) for focusing input light on the digital image sensor 420, which comprises an array of pixel elements (cameras of 5 and 8 mega-pixel resolution are common, but other resolutions may be practiced). The electronic light modulator 410 is disposed between the optical lens system (not shown in FIG. 4) and the digital image sensor 420 to modulate transmission of the input light onto the same pixel elements of the digital image sensor 420. That is, the electronic light modulator 410 affects different exposure levels of light incident on the image sensor 420 by controlling or modulating the luminous flux through the modulator 410. The digital image sensor 420 may comprise a charge-coupled device (CCD) or CMOS sensor array, but other types of sensors capable of producing a digital image may be practiced. The electronic light modulator 410 may comprise a liquid crystal display (LCD) 412, a liquid crystal on silicon (LCOS) device (not shown in FIG. 4), or a digital light processor (DLP) 414. The digital image sensor 420 and the light modulator 410 are operated in a coordinated manner to capture or produce frames of an image having different exposure levels 440A, 440B, 440C. The image processing unit or processor 430 processes the different exposure frames of the image to produce a high dynamic range digital image.

While not explicitly shown in FIG. 4, the device 400 further comprises a controller for controlling the digital image sensor 420 and the electronic light modulator 410 to be operable in a coordinated manner. The controller may be a digital processing device, such as a digital signal processor or microprocessor. Alternatively, the image processing unit 430 operates as a controller for controlling the digital image sensor 420 and the light modulator 410. Further, the image processing unit 430 may comprise a digital signal processor or microprocessor.

While not explicitly shown in FIG. 4, the device 400 further comprises a photo-sensor coupled to the controller to sense ambient lighting to effect coordinated operation of the digital image sensor 420 and the electronic light modulator 410. For example, if the photo-sensor senses the ambient light is normal condition, the transmissions for 440A, 440B and 440C may be 80%, 60% and 40%, respectively. But in a brighter ambient condition sensed by photo-sensor, the controller reduces the transmission by the electronic light modulator 410, e.g., 60%, 40% and 20%, to gain the proper exposure level images, i.e. 440A, 440B and 440C. If the ambient condition sensed by the photo-sensor is darker, the controller increases the transmission by the electronic light modulator 410, such like 100%, 80% and 60%, to gain the proper exposure level images, i.e. 440A, 440B and 440C.

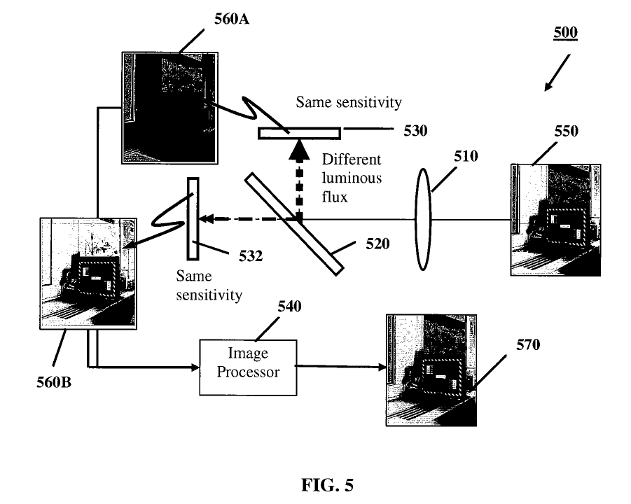

FIG. 5 is a block diagram of a digital image capture device 500 in accordance with an embodiment of the invention. The device 500 comprises two or more digital image sensors 530, 532, each comprising a plurality of pixel elements, a light extraction unit 520, and an image processing unit 540. The device 500 may also comprise an optical lens system 510 for focusing input light on the image sensors 530, 532 to capture frames of the image 550. While only a single lens 510 is shown in FIG. 5, it will be understood that more complex optical lens systems may be practiced. The digital image sensors 530, 532 may comprise charge-coupled devices (CCD), or CMOS sensor arrays, or a combination thereof. Preferably, the sensors 530, 532 have the same or substantially the same sensitivity, but may have different sensitivities.

The light extraction unit 520 is disposed between the optical lens system 510 and the image sensors 530, 532 adapted to transmit a portion of the input light onto the same pixel elements of respective digital image sensors 530, 532 to produce frames 560A, 560B of the image 550 having different exposures. The light extraction unit 520 comprises a beam splitter. The light extraction unit 520 may further comprises one or more optical coatings for modulating transmission of the input light to the respective digital image sensors 530, 532. The light extraction unit 520 provides different luminous flux to at least two of the same or different sensitivity sensors 530, 532. The image processing unit 540 processes the different exposure frames 560A, 560B of the image 550 to produce a high dynamic range digital image 570.

In FIG. 5, the light extraction unit 520 further provides the same luminous flux light to at least two of the different sensitivities sensors 530, 532 to produce frames 560A and 560B in different exposure level. The image processing unit 540 processes the different frames of the image 550 to produce a high dynamic range digital image 570.

Again, while not explicitly shown in FIG. 5, the device 500 further comprises a controller for controlling the digital image sensors 530, 532. The controller may be a digital processing device, such as a digital signal processor or microprocessor. Alternatively, the image processing unit 540 operates as a controller for controlling the digital image sensors 530, 532. Further, the image processing unit 540 may comprise a digital signal processor or microprocessor. Again, the digital image capture device may be a still image camera, or a video camera for recording digital video, or capable of both operations.

Any of a number of known frame-merging techniques may be used to merge frames with different exposures. One such technique is described by Rodrigo Damazio and Bruno Barberi Gnecco, “A codec architecture for real-time High Dynamic Range video”, Symposium on Virtual Reality [SVR] VIII, 2-5 May 2006, Belem (PA), ISBN 857669067-5, (http://bibliotecadigital.sbc.org.br/download.php?paper=429). In particular, in section 3.1 entitled “Encoding algorithm” of the Damazio article, an encoding algorithm is described that achieves a high dynamic range value using a weighted sum of differently exposed images. The irradiance is:

$$ln {E}_{i} = \frac{{\sum }_{e = 1}^{P} w ( {Z}_{e , i} ) \cdot ( g ( {Z}_{e , i} ) - ln Δ {t}_{e} )}{{\sum }_{e = 1}^{P} w ( {Z}_{e , i} )}$$

where Δt is the exposure time for an exposure e, Z_{e,i} are pixel values from position i for exposure e, w(Z_{e,i}) is a weight vector assign different weights to an image, and g(Z) is a response function to each intensity value. A weighting vector is given in section 3.2 entitled “Image weighting functions”:

$${w}_{ij} ( {Z}_{e , i} ) = exp ( \frac{- {( {Z}_{e , i} - 127.5 )}^{2}}{{127.5}^{2}} )$$

Further details are set forth in the article, the contents of which are incorporated herein by reference.

Smooth response functions are described by Paul Debevec and Jitendra Malik, “Recovering High Dynamic Range Radiance Maps from Photographs”, SIGGRAPH 97, August 1997, (http://www.debevec.org/Research/HDR/#publications) and a slide presentation by the same authors, “Recovering High Dynamic Range Radiance Maps from Photographs”, Computer Science Division, University of California at Berkeley, August 1997, and particularly slides 5 and 6. Both documents are incorporated herein by reference. Assuming unit radiance for each pixel, the radiances are adjusted to obtain a smooth response curve for pixel value as a function of in exposure.

A small number of embodiments of the invention regarding methods and apparatuses for capturing at least one digital image have been described. In the light of the foregoing, it will be apparent to those skilled in the art in the light of this disclosure that various modifications and/or substitutions may be made without departing from the scope and spirit of the invention.

1. A digital image capture device, comprising:
a digital image sensor comprising a plurality of pixel elements;
an electronic light modulator disposed between incident light and said image sensor to modulate transmission of said input light onto the same pixel elements of said digital image sensor, said digital image sensor and said light modulator operable in a coordinated manner to produce a plurality of frames of an image having different exposures; and
an image processing unit to process said different exposure frames of said image to produce a high dynamic range digital image.

2. The digital image capture device as claimed in claim 1, further comprising an optical lens system for focusing input light on said image sensor.

3. The digital image capture device as claimed in claim 1, further comprising a controller for controlling said digital image sensor and said light modulator to be operable in a coordinated manner.

4. The digital image capture device as claimed in claim 3, wherein said controller is a digital processing device.

5. The digital image capture device as claimed in claim 1, wherein said image processing unit operates as a controller for controlling said digital image sensor and said light modulator to be operable in a coordinated manner.

6. The digital image capture device as claimed in claim 3, further comprising a sensor coupled to said controller to sense ambient lighting to effect coordinated operation of said digital image sensor and said electronic light modulator.

7. The digital image capture device as claimed in claim 1, wherein said digital image sensor comprises a charge-coupled device (CCD) or CMOS sensor array.

8. The digital image capture device as claimed in claim 1, wherein said light modulator comprises a liquid crystal display (LCD), a liquid crystal on silicon (LCOS) device, or a digital light processor (DLP).

9. The digital image capture device as claimed in claim 1, wherein said image processing unit comprises a digital signal processor.

10. The digital image capture device as claimed in claim 2, wherein said digital image capture device is a still image camera.

11. The digital image capture device as claimed in claim 2, wherein said digital image capture device is a video camera for recording digital video.

12. A method of capturing at least one digital image, said method comprising the steps of:
modulating transmission of input light onto the same pixel elements of a digital image sensor comprising a plurality of pixel elements;
capturing a plurality of frames of an image having different exposures from said modulated transmission of said input light using said digital image sensor; and
processing said different exposure frames of said image to produce a high dynamic range digital image.

13. The method as claimed in claim 11, further comprising the step of focusing said input light on said digital image sensor.

14. The method as claimed in claim 11, further comprising the step of controlling said digital image sensor and an electronic light modulator to be operable in a coordinated manner.

15. The method as claimed in claim 14, further comprising the step of sensing ambient lighting to effect coordinated operation of said digital image sensor and said electronic light modulator.

16. The method as claimed in claim 11, wherein said digital image sensor comprises a charge-coupled device (CCD) or CMOS sensor array.

17. The method as claimed in claim 11, wherein said modulating step is implemented using a liquid crystal display (LCD), a liquid crystal on silicon (LCOS) device, or a digital light processor (DLP).

18. A digital image capture device, comprising:
a plurality of digital image sensors each comprising a plurality of pixel elements;
an optical light extraction unit disposed between input light and said image sensors adapted to transmit a portion of said input light onto the same pixel elements of respective digital image sensors to produce a plurality of frames of an image having different exposures; and
an image processing unit to process said different exposure frames of said image to produce a high dynamic range digital image.

19. The digital image capture device as claimed in claim 18, further comprising an optical lens system for focusing said input light on said image sensors.

20. The digital image capture device as claimed in claim 18, further comprising a controller for controlling said digital image sensors to be operable in a coordinated manner.

21. The digital image capture device as claimed in claim 20, wherein said controller is a digital processing device.

22. The digital image capture device as claimed in claim 18, wherein said image processing unit operates as a controller for controlling said digital image sensors to be operable in a coordinated manner.

23. The digital image capture device as claimed in claim 18, wherein said digital image sensors comprise charge-coupled devices (CCD), or CMOS sensor arrays, or a combination thereof.

24. The digital image capture device as claimed in claim 18, wherein said light extraction unit comprises a beam splitter.

25. The digital image capture device as claimed in claim 24, wherein said light extraction unit further comprises one or more optical coatings for modulating transmission of said input light to respective digital image sensors.

26. The digital image capture device as claimed in claim 18, wherein said image processing unit comprises a digital signal processor.

27. The digital image capture device as claimed in claim 19, wherein said digital image capture device is a still image camera.

28. The digital image capture device as claimed in claim 19, wherein said digital image capture device is a video camera for recording digital video.

29. The digital image capture device as claimed in claim 19, wherein said light extraction unit provides different luminous flux to at least two of said digital image sensors.

30. The digital image capture device as claimed in claim 29, wherein said at least two of said digital image sensors have the same or substantially the same sensitivity.

31. The digital image capture device as claimed in claim 29, wherein said at least two of said digital image sensors have different sensitivities.

32. The digital image capture device as claimed in claim 29, wherein said image processing unit processes the different exposure frames of the image to produce a high dynamic range digital image.

33. A method of capturing at least one digital image, said method comprising the steps of:
transmitting a portion of input light onto the same pixel elements of respective digital image sensors, each comprising a plurality of pixel elements, to produce a plurality of frames of an image having different exposures; and
processing said different exposure frames of said image to produce a high dynamic range digital image.

34. The method as claimed in claim 33, further comprising the step of focusing input light on said digital image sensors.

35. The method as claimed in claim 33, further comprising the step of controlling said digital image sensors to be operable in a coordinated manner.

36. The method as claimed in claim 33, wherein said digital image sensors comprise charge-coupled devices (CCD), or CMOS sensor arrays, or a combination thereof.

37. The method as claimed in claim 33, wherein said transmitting step is implemented using an optical light extraction unit.

38. The method as claimed in claim 37, wherein said light extraction unit comprises a beam splitter.

39. The method as claimed in claim 38, wherein said light extraction unit further comprises one or more optical coatings for modulating transmission of said input light to respective digital image sensors.

40. The method as claimed in claim 33, further comprising the step of providing different luminous flux to at least two of said digital image sensors.

41. The method as claimed in claim 40, wherein said at least two of said digital image sensors have the same or substantially the same sensitivity.

42. The method as claimed in claim 40, wherein said at least two of said digital image sensors have different sensitivities.

43. The method as claimed in claim 40, wherein said image processing unit processes the different exposure frames of the image to produce a high dynamic range digital image.
